(19) United States
(12) Patent Application Publication
(10) Pub. No.: US 2017/0275199 A1
(43) Pub. Date: Sep. 28, 2017

(54) OPTICAL FIBER PREFORM MANUFACTURING METHOD AND MANUFACTURING APPARATUS

(71) Applicant: Shin-Etsu Chemical Co., Ltd., Tokyo (JP)

(72) Inventor: Tetsuya OTOSAKA, Ibaraki (JP)

(21) Appl. No.: 15/466,875

(22) Filed: Mar. 23, 2017

(30) Foreign Application Priority Data
Mar. 25, 2016 (JP) 2016-061252

(51) Int. Cl. C03B 37/025

(52) U.S. Cl. CPC C03B 37/0253

(57) ABSTRACT

To restrict deterioration of non-circularity in a constricted portion of an optical fiber preform, provided is an optical fiber preform manufacturing method including introducing inert gas along a surface of the optical fiber preform, causing the inert gas to circulate around the optical fiber preform with an axis of the optical fiber preform in a longitudinal direction as a center, and heating the optical fiber preform in an inert gas environment. In this manufacturing method, the inert gas may be introduced in a direction parallel to a tangent line of the optical fiber preform in a plane orthogonal to the axis.

The contents of the following Japanese patent application are incorporated herein by reference:
NO. 2016-061252 filed on Mar. 25, 2016.

### BACKGROUND

1. Technical Field

The present invention relates to an optical fiber preform manufacturing method and manufacturing apparatus.

2. Related Art

An optical fiber preform is manufactured by applying a tensile force to an optical fiber base material in a heated state. Furthermore, there are cases where the optical fiber preform has dimensions and a shape that are adjusted by applying the tensile force in the heated state, to form an optical fiber preform for drawing.
Patent Document 1: Japanese Patent Application Publication No. H05-024877

The optical fiber preform includes a trunk portion with a substantially constant diameter and a tapered constricted portion formed at an end portion. As an example, even when the non-circularity of the trunk portion in the optical fiber preform is less than 0.2%, the there are cases where the constricted portion has non-circularity from 0.6% to 1.0%. Optical fiber with poor non-circularity is drawn from a constricted portion with poor non-circularity. Therefore, there are more portions that are disposed of, and the yield of the optical fiber base material is worsened.

### SUMMARY

According to a first aspect of the present invention, provided is a manufacturing method for manufacturing an optical fiber preform by heating in an inert gas atmosphere, the manufacturing method comprising introducing the inert gas along a surface of the optical fiber preform and causing the inert gas to circulate around the optical fiber preform with an axis of the optical fiber preform in a longitudinal direction as a center.

According to a second aspect of the present invention, provided is a manufacturing apparatus for manufacturing an optical fiber preform by heating in an inert gas atmosphere, the manufacturing apparatus comprising an introduction nozzle that introduces the inert gas along a surface of the optical fiber preform and causes the inert gas to circulate around the optical fiber preform with an axis of the optical fiber preform in a longitudinal direction as a center.

The summary clause does not necessarily describe all necessary features of the embodiments of the present invention. The present invention may also be a sub-combination of the features described above.

### BRIEF DESCRIPTION OF THE DRAWINGS

FIG. 1 is a schematic cross-sectional view of a manufacturing apparatus 10.

FIG. 2 is a schematic cross-sectional view of the manufacturing apparatus 10.

FIG. 3 is a schematic cross-sectional view of the manufacturing apparatus 10.

FIG. 4 is a schematic cross-sectional view of the manufacturing apparatus 10.

FIG. 5 is an enlarged schematic cross-sectional view of a region near the gas introduction nozzle 800 in the manufacturing apparatus 10.

FIG. 6 is a graph showing the non-circularity and the change in outer diameter of the optical fiber preform 600.

FIG. 7 is an enlarged schematic cross-sectional view of a region near the gas introduction nozzle 800 in the manufacturing apparatus 11.

FIG. 8 is a graph showing the non-circularity and the change in outer diameter of the optical fiber preform 600.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

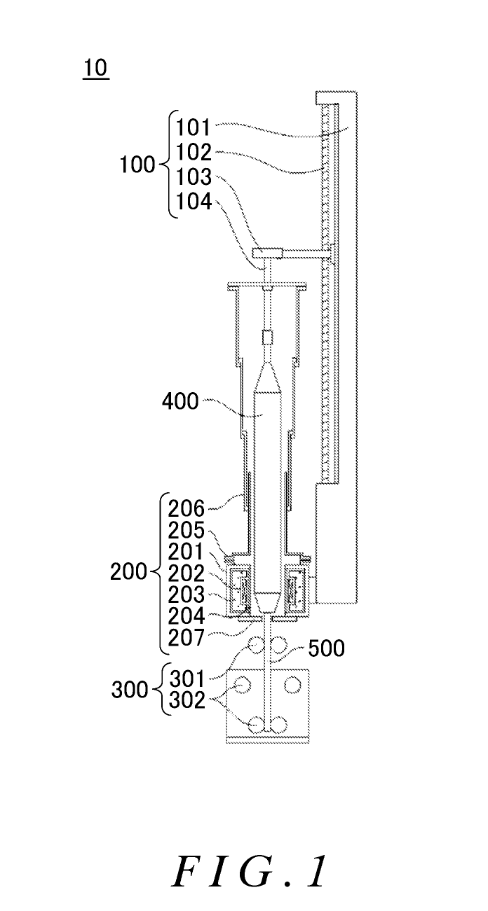

FIG. 1 is a schematic cross-sectional view of a manufacturing apparatus 10. The manufacturing apparatus 10 includes a feeding apparatus 100, a heating apparatus 200, and a pulling apparatus 300.

The feeding apparatus 100 includes a column 101, a ball screw 102, a raising and lowering section 103, and a hanging shaft 104. The column 101 is shaped to be long in the direction of gravity, and rotatably supports the top end and the bottom end of the ball screw 102. The ball screw 102 is driven by a motor, which is not shown in the drawings, and rotates on a rotational axis arranged in the longitudinal direction.

The raising and lowering section 103 engages with the ball screw 102 and is driven by the rotating ball screw 102 to be raised and lowered along the longitudinal direction of the column 101. The top end of the hanging shaft 104 in the drawing engages with the raising and lowering section 103, and the bottom end of the hanging shaft 104 in the drawing engages with the top end of the optical fiber base material 400 or the like, which is the target of the machining. In this way, the optical fiber base material 400 can be raised and lowered in accordance with the raising and lowering of the raising and lowering section 103.

The heating apparatus 200 includes a furnace body 201, a heater 202, a thermal insulation material 203, and a muffle tube 204. The heating apparatus 200 includes a gas introducing portion 205 and a top chamber 206 on the top portion of the furnace body 201. Furthermore, the heating apparatus 200 includes a bottom furnace shutter 207 on the bottom portion of the furnace body 201.

The furnace body 201 surrounds the entire heating apparatus 200, and blocks off the optical fiber base material 400 and other components from the outside atmosphere. Furthermore, the furnace body 201 engages with the column 101 of the feeding apparatus 100, such that the positions of these components are fixed relative to each other. Accordingly, when the feeding apparatus 100 operates, the relative positions of the heating apparatus 200 and the optical fiber base material 400 in the height direction change.

The heater 202 surrounds a portion of the optical fiber base material 400 in the longitudinal direction and heats this portion. An electric heater can be used as the heater 202. In this way, for example, it is possible to handle the large diameters of recent optical fiber preforms that have diameters exceeding 100 mm, such as when manufacturing an optical fiber preform with a diameter of 150 mm from an optical fiber base material 400 with a diameter of 200 mm.

The thermal insulation material 203 is arranged between the outer circumference side of the heater 202 and the inner surface of the furnace body 201. In this way, the heat generated by the heater 202 can be used efficiently. Furthermore, in order to prevent contamination of the optical fiber base material 400 or the like due to the carbon or the like forming the heater 202, the inner wall of the heater 202 is wrapped by the muffle tube 204.

The gas introducing portion 205 and the top chamber 206 are arranged to be sequentially layered on the top side of the heating apparatus 200 in the drawing. The gas introducing portion 205 creates communication between the inside and outside of the furnace body 201, and is an opening adjacent to the heater 202 and the muffle tube 204 in the longitudinal direction of the optical fiber base material 400 inside the furnace body 201. The gas introducing portion 205 in the drawing is a component exhibiting a function of creating communication between the inside and outside of the furnace body 201, and the shape and the like of the gas inlet opening itself is not indicated by the drawing.

In the heating apparatus 200, inert gas including argon gas, nitrogen gas, and the like can be introduced to the surface of the optical fiber base material 400 directly above the heater 202 and the muffle tube 204 in the drawing, by passing through the gas introducing portion 205. The introduced inert gas is supplied to the inside of the furnace body 201 as well, to prevent oxidization of the heater 202 and the thermal insulation material 203.

The top chamber 206, along with the furnace body 201, blocks off the optical fiber base material 400 from the outside atmosphere. The top chamber 206 is an expanding and contracting chamber formed by interconnecting a plurality of pipes with diameters that become sequentially smaller, and expands and contracts according to the raising and lowering of the raising and lowering section 103 and the hanging shaft 104. In this way, the volume of the inert gas layer formed around the optical fiber base material 400 can be reduced, and the amount of inert gas that is used can be restricted.

The bottom furnace shutter 207 expands and contracts the inner diameter of the opening through which the optical fiber base material 400 is inserted in the bottom surface of the furnace body 201. In this way, even when the diameter of the optical fiber base material 400 changes, an air-tight state can be maintained between the furnace body 201 and the optical fiber base material 400.

The pulling apparatus 300 is arranged below the heating apparatus 200 and includes a plurality of rollers, including guide rollers 301 and pulling rollers 302. The guide rollers 301 and the pulling rollers 302 are each a pair of rollers that sandwich an extension line of the optical fiber base material 400 from the sides. Each roller pair can sandwich the optical fiber base material 400 or the dummy bar 500 running therebetween while changing the space between these rollers.

The guide rollers 301 sandwich the optical fiber base material 400 or the dummy bar 500 protruding from the bottom surface of the furnace body 201 near the bottom ends thereof, and guide the optical fiber base material 400 or the dummy bar 500 between the pulling rollers 302. The pulling rollers 302 are rotationally driven to pull the sandwiched optical fiber base material 400 or the like downward in the drawing. In this way, the pulling apparatus 300 can apply the tensile force to the optical fiber base material 400 between the pulling apparatus 300 and the hanging shaft 104. Furthermore, when the optical fiber base material 400 is lowered by the feeding apparatus 100, the pulling apparatus 300 sandwiches and pulls the optical fiber base material 400 itself downward in the drawing.

In this way, no matter which portion of the optical fiber base material 400 in the longitudinal direction is being heated by the heating apparatus 200, the pulling apparatus 300 can exert the tensile force on the optical fiber base material 400. Accordingly, by having the pulling apparatus 300 exert the tensile force on the optical fiber base material 400 that has a portion thereof softened by the heating, the softened portion of the optical fiber base material 400 can be elongated to realize a smaller diameter or to be severed. Furthermore, in the process of severing the optical fiber base material 400, a tapered constricted portion can also be formed at the end portion where the optical fiber base material 400 is severed.

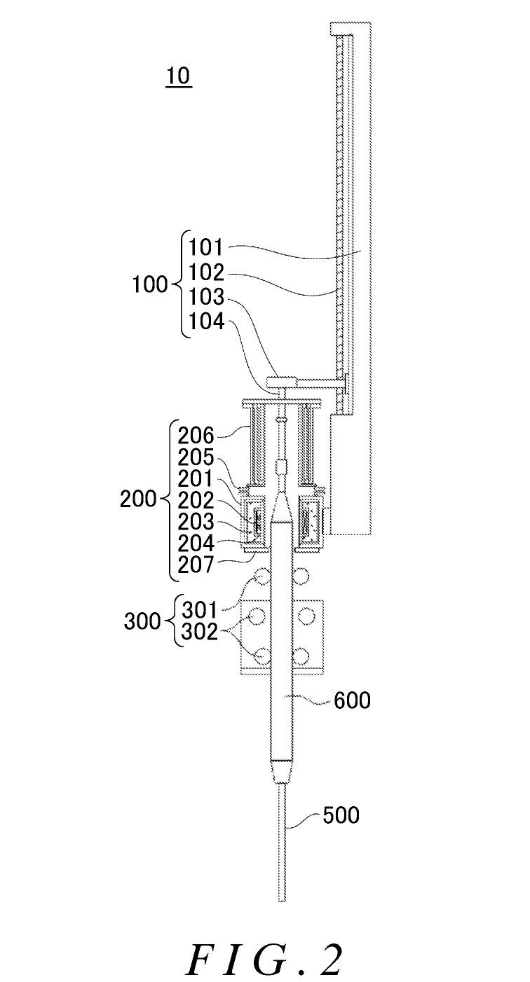

The manufacturing apparatus 10 described above can be used in the manufacturing of the optical fiber preform 600 (see FIG. 2), for example. The optical fiber base material 400 made of quartz glass and manufactured via a sintering process such as OVD (Outside Vapor Deposition), VAD (Vapor Axial Deposition), or the like has an outer diameter that fluctuates in the longitudinal direction due to the effect of gravity. Therefore, when the optical fiber base material 400 is drawn into optical fiber as-is, it becomes difficult to maintain the gas seal with the drawing apparatus. Therefore, before drawing the optical fiber, the outer diameter of the optical fiber base material 400 is adjusted through elongation machining using the manufacturing apparatus 10, and the optical fiber preform 600 with less fluctuation in the outer diameter is manufactured.

As shown in FIG. 1, in the elongation machining using the manufacturing apparatus 10, the optical fiber base material 400 having its top end in the drawing held by the hanging shaft 104 has its bottom end in the drawing hang down to the position that is heated by the heater 202. The bottom end of the optical fiber base material 400 in the drawing is engaged with the dummy bar 500. The bottom end side of the dummy bar 500 in the drawing extends below the optical fiber base material 400 until reaching the pulling apparatus 300, and is sandwiched by the guide rollers 301 and the pulling rollers 302.

Next, with the optical fiber base material 400 in a state of being heated and softened by the heating apparatus 200, the tensile force is applied to the optical fiber base material 400 by the pulling apparatus 300 and the diameter of the optical fiber base material 400 is reduced. Next, the optical fiber base material 400 is gradually lowered by the feeding apparatus 100, and the diameter of the optical fiber base material 400 becomes sequentially smaller from the bottom end thereof

Furthermore, as shown in FIG. 2, in the lowering process, the pulling by the pulling apparatus 300 changes from being applied to the dummy bar 500 to being applied to the optical fiber base material 400 itself In this way, the elongation machining can be applied up to the top end of the optical fiber base material 400. By adjusting the ratio of the diameter reduction in such an elongation machining process, the diameter of the optical fiber base material 400 is made uniform over the entire length thereof, and the optical fiber preform 600 suitable for drawing optical fiber is manufactured.

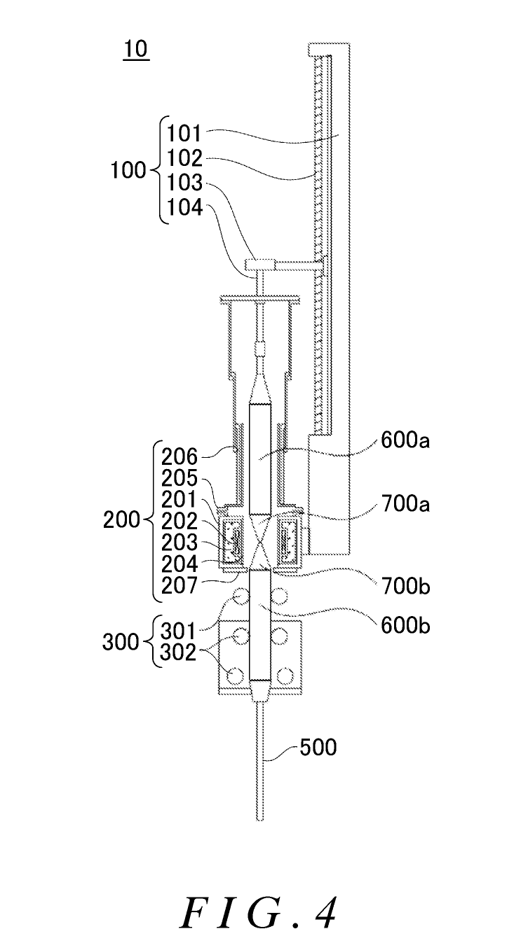

Furthermore, the manufacturing apparatus 10 can also be used in constricting machining to form lead-out portions 700a and 700b (see FIG. 4) in the optical fiber preform 600. The lead-out portions 700a and 700b are formed at end portions of the trunk portion having a constant diameter in the optical fiber preform 600. At the lead-out portions 700a and 700b, a tapered shape is formed with a diameter that changes continuously from the trunk portion to the end portion with a small diameter suitable for starting the drawing of the optical fiber. Accordingly, the machining for forming the lead-out portions 700a and 700b by adjusting the shapes of the end portions of the optical fiber preform 600 is referred to as lead-out machining or constriction machining. In the following description, in order to avoid overly complicated explanations, the machining to form the lead-out portions 700a and 700b is referred to as lead-out machining.

In a case where the lead-out machining is performed using the manufacturing apparatus 10, first, the temperature of the heater 202 is lowered to a temperature at which the optical fiber preform 600 hardens, e.g. a temperature of 1200° C. In this way, the optical fiber preform 600 that has been softened in the elongation machining process enters a state where it does not substantially deform.

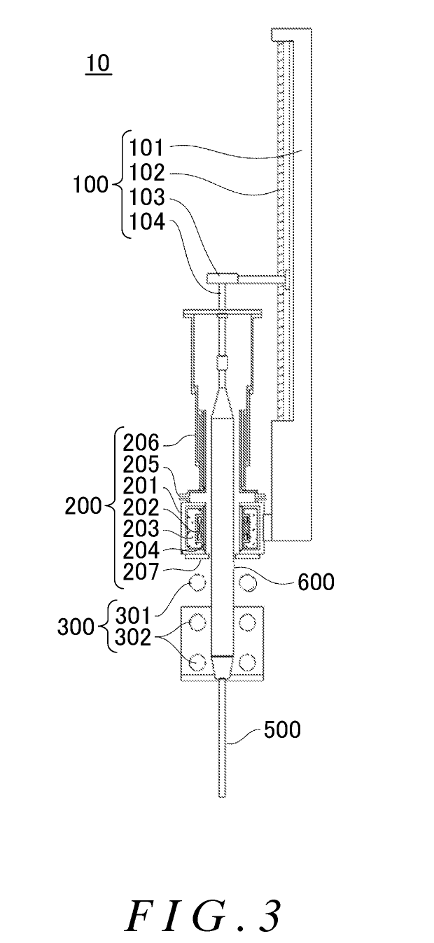

Next, as shown in FIG. 3, in a state where the guide rollers 301 and the pulling rollers 302 have released the hold on the optical fiber preform 600, the optical fiber preform 600 is raised by the feeding apparatus 100. In this way, the positions where the lead-out portions 700a and 700b are formed in the optical fiber preform 600 are aligned with the center of the heating apparatus 200.

Next, the temperature of the heating apparatus 200 is again raised, and the optical fiber preform 600 is softened. Furthermore, as shown in FIG. 4, the space between the guide rollers 301 and between the pulling rollers 302 in the pulling apparatus 300 is reduced to sandwich the optical fiber preform 600 or the dummy bar 500. Furthermore, the tensile force is applied to the optical fiber preform 600 by driving the pulling roller 302, and a constricted shape is formed at the softened portion of the optical fiber preform 600.

Furthermore, during the formation of the constricted shape, the top end of the optical fiber preform 600 may be raised by the feeding apparatus 100 in parallel with the pulling of the optical fiber preform 600 by the pulling apparatus 300. In this way, the lead-out portions 700a and 700b are respectively formed simultaneously at the bottom end of the top-side optical fiber preform 600a and the top end of the bottom-side optical fiber preform 600b.

In the above example, the lead-out portions are formed in the middle of the optical fiber preform 600 in the longitudinal direction. Therefore, the optical fiber preform 600 is severed between the lead-out portion 700a and the lead-out portion 700b according to the lead-out machining. By performing the lead-out machining at an end portion of the optical fiber preform 600, it is also possible to form the lead-out portions 700a and 700b without severing the optical fiber preform 600.

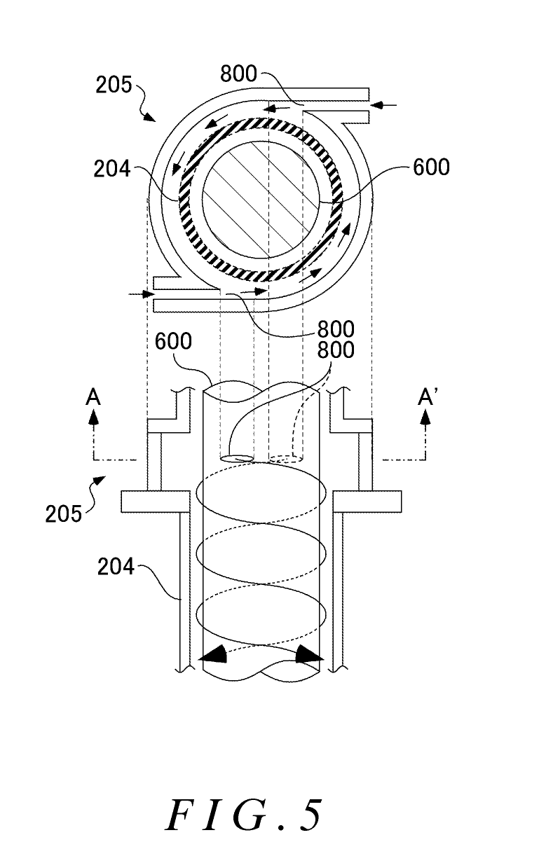

FIG. 5 is an enlarged schematic cross-sectional view of a region near the gas introducing portion 205 in the manufacturing apparatus 10. The top portion of FIG. 5 shows a partial cross section in a plane orthogonal to the center axis along which the optical fiber preform 600 is elongated in the longitudinal direction, i.e. a horizontal cross section. The bottom portion of FIG. 5 shows a partial cross section in a plane including the center axis along which the optical fiber preform 600 is elongated in the longitudinal direction, i.e. a vertical cross section. Furthermore, the horizontal cross section described above is also a cross section in the A-A′ plane passing through the gas introducing portion 205 in the vertical cross section.

In the viewpoint of FIG. 5, there are also cases where the optical fiber base material 400 appears instead of the optical fiber preform 600. In the description of FIG. 5, in order to avoid overly complicated explanations, the object loaded in the manufacturing apparatus 10 will always be referred to as the optical fiber preform 600.

As shown in the top portion of the drawing, the gas introducing portion 205 has a flow path parallel to the tangent of the optical fiber preform 600. One end of the flow path opens in the inner surface of the furnace wall, and forms an introduction nozzle 800. When the inert gas is introduced through the flow path from outside the gas introducing portion 205, the inert gas flows along the inner surface of the furnace wall or along the circumferential surface of the optical fiber base material 400 inside the gas introducing portion 205. Furthermore, the gas introducing portion 205 of the manufacturing apparatus 10 includes a pair of flow paths that are arranged with a uniform distance therebetween in the circumferential direction, and a pair of the introduction nozzles 800 are formed that both introduce the inert gas in the same direction, in the circumferential direction of the optical fiber base material 400.

A portion of the inert gas introduced to the gas introducing portion 205 flows between the optical fiber base material 400 and the top chamber 206. In this way, a portion of the inert gas that has reached the top end of the manufacturing apparatus 10 finally flows to the outside of the top chamber 206 from a gap created in the periphery of the hanging shaft 104.

On the other hand, a large layer of introduced inert gas flows between the optical fiber base material 400 and the muffle tube 204, and flows to the outside from the bottom end of the furnace body 201. Therefore, the inert gas introduced from the gas introducing portion 205 flows downward in the drawing inside the furnace body 201 while moving horizontally due to the introduction nozzles 800. Accordingly, inside the furnace body 201, a spiral flow is created in which the inert gas flows downward while rotating along the circumferential surface of the optical fiber base material 400, as shown in the bottom portion of FIG. 2. Furthermore, a spiral flow is created in which the inert gas introduced from each of the plurality of introduction nozzles 800 rotates in the same direction inside the furnace body.

In this way, the uneven distribution of the inert gas in the circumferential direction of the optical fiber base material 400 is ameliorated, and the entire optical fiber base material 400 is covered by the inert gas. Accordingly, the optical fiber base material 400 is cut off from oxygen gas or the like contained in the outside atmosphere, and deterioration due to oxidization or the like occurring when the heating apparatus 200 performs the heating is restricted.

Furthermore, the introduction nozzles 800 of the manufacturing apparatus 10 are arranged such that the ejection directions have directional components that are tangential to the optical fiber preform 600, and therefore the inert gas ejected from the introduction nozzles 800 flows in a manner to circulate around the optical fiber preform 600. In this way, the uneven temperature distribution of the surface of the optical fiber preform 600 caused by the uneven distribution of the inert gas is ameliorated, and the increase in the non-circularity of the lead-out portions 700a and 700b formed to have constricted shapes is restricted.

Here, the non-circularity of the optical fiber preform 600 is a value obtained by measuring the outer diameter of the optical fiber preform 600, and is expressed as shown below in Expression 1 when the maximum diameter is D_{MAX}, the minimum diameter is D_{MIN}, and the average diameter is D_{AVE}.

non-circularity [%]=(D_{MAX}−D_{MIN})/D_{AVE}×100 (1)

### Embodiment Example

An optical fiber preform 600 with an outer diameter of 150 mm was manufactured from an optical fiber base material 400 with a maximum outer diameter of 200 mm, through elongation machining using the manufacturing apparatus 10. Furthermore, two optical fiber preforms 600 suitable for optical fiber drawing were manufactured in which the lead-out portions 700a and 700b were formed in the center of the optical fiber preform 600 in the longitudinal direction, through lead-out machining using the manufacturing apparatus 10.

As shown in FIG. 5, two introduction nozzles 800 of the manufacturing apparatus 10 were arranged to have ejection directions having directional components tangential to the optical fiber preform 600 in a radial cross section thereof. The cross sectional area of each introduction nozzle 800 was 40 mm², and nitrogen gas was introduced from each introduction nozzle 800 at a rate of 75 L per minute.

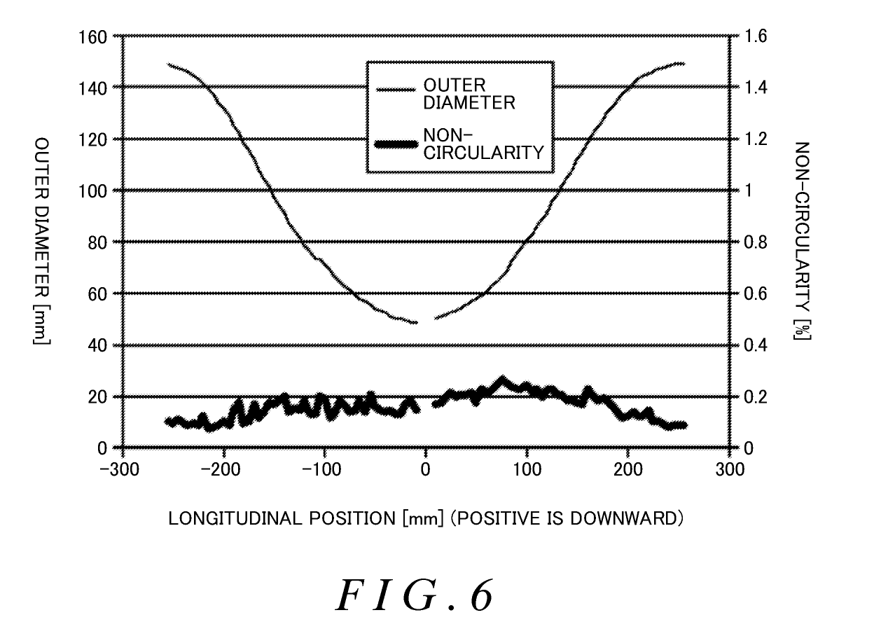

FIG. 6 is a graph showing the measurement results of the non-circularity of the optical fiber preform 600 suitable for optical fiber drawing that was manufactured using the above conditions. As shown in FIG. 6, the non-circularity of the optical fiber preform 600 was at most less than or equal to 0.24% at any one of the lead-out portions 700a and 700b.

### Comparative Example

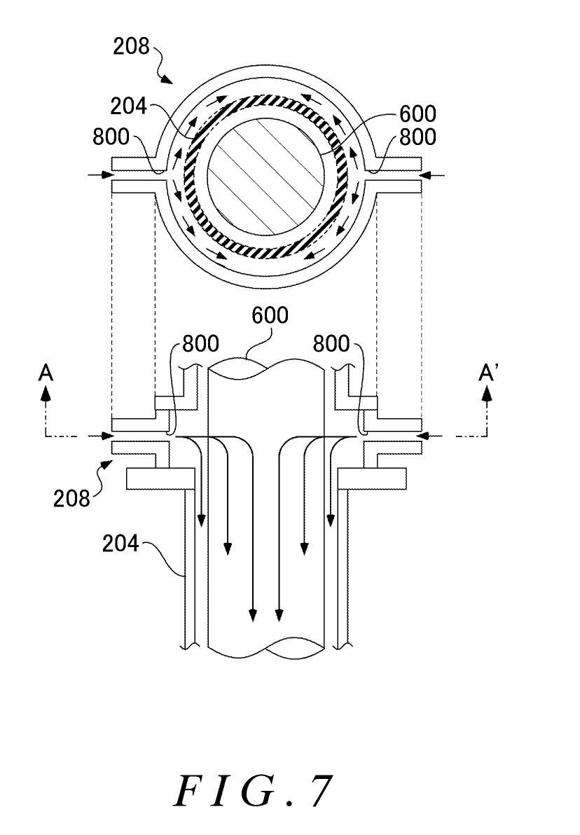

FIG. 7 is an enlarged schematic cross-sectional view of the region near the gas introducing portion 208 in another manufacturing apparatus 11. The top portion of FIG. 7 shows a partial cross section in a plane orthogonal to the center axis along which the optical fiber preform 600 is elongated in the longitudinal direction, i.e. a horizontal cross section. The bottom portion of FIG. 7 shows a partial cross section in a plane including the center axis along which the optical fiber preform 600 is elongated in the longitudinal direction, i.e. a vertical cross section. Furthermore, the horizontal cross section described above is also a cross section in the A-A′ plane passing through the gas introducing portion 205 in the vertical cross section.

As shown in the top portion of FIG. 7, the gas introducing portion 208 of the manufacturing apparatus 11 has a pair of introduction nozzles 800 that each have an introduction direction orthogonal to a normal line of the optical fiber preform 600. Therefore, the inert gas introduced from each introduction nozzle 800 in the pair splits into flowing clockwise and flowing counter-clockwise in the drawing along the surface of the optical fiber preform 600, and when the inert gas from one of the introduction nozzles 800 has circulated approximately 90° around the optical fiber preform 600, this flow of inert gas collides with the flow of inert gas introduced from the other introduction nozzle 800.

Therefore, as shown in the bottom portion of FIG. 7, the flow rate of the inert gas on the surface of the optical fiber preform 600 becomes relatively large in the center in the drawing and becomes relatively small at both ends at the sides in the drawing. Therefore, when the inert gas is continuously introduced, the cooling of the optical fiber preform 600 caused by the inert gas becomes uneven, and a temperature distribution occurs in the optical fiber preform 600. The temperature distribution in the optical fiber preform 600 is expressed as a viscosity distribution when the optical fiber preform 600 is softened, and therefore the increase in non-circularity becomes more significant when the elongation machining or lead-out machining is performed by applying the tensile force to the optical fiber preform 600.

An optical fiber preform 600 with an outer diameter of 150 mm was manufactured from an optical fiber base material 400 with a maximum outer diameter of 200 mm, through elongation machining using the manufacturing apparatus 11. Furthermore, two optical fiber preforms 600 suitable for optical fiber drawing were manufactured, through lead-out machining using the manufacturing apparatus 11.

As shown in FIG. 7, two introduction nozzles 800 of the manufacturing apparatus 11 were provided. Each introduction nozzle 800 has an ejection direction toward the optical fiber preform 600, and does not have any tangential directional components in a radial cross section. The cross-sectional area of each introduction nozzle 800 was 40 mm², and nitrogen gas was introduced from each introduction nozzle 800 at a rate of 75 L per minute.

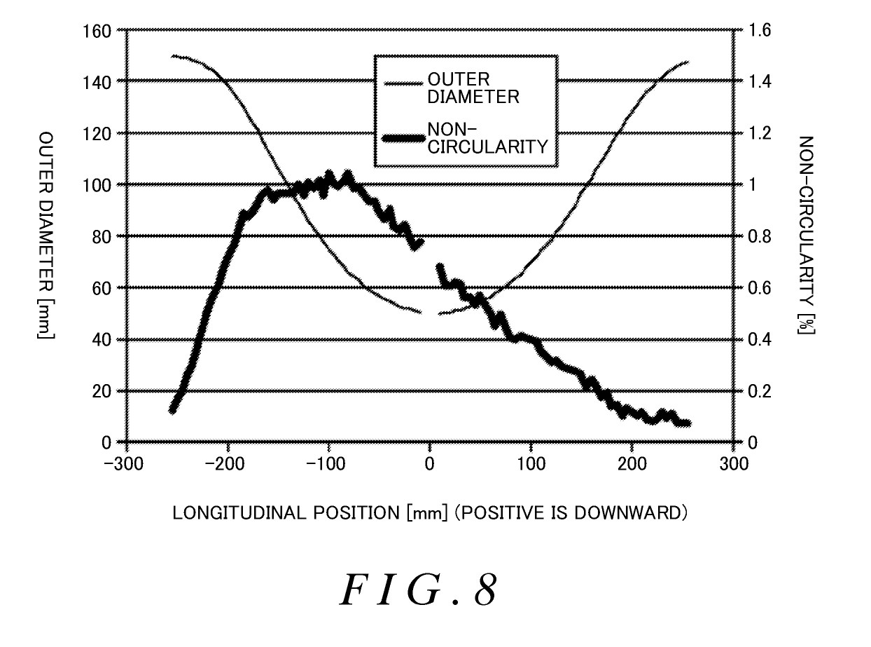

FIG. 8 is a graph showing the measurement results of the non-circularity of the optical fiber preform 600 suitable for optical fiber drawing that was manufactured using the above conditions. As shown in FIG. 8, the non-circularity of the optical fiber preform 600 reached a maximum of 01.05%.

In the embodiment example and the comparative example described above, the lead-out machining was performed in the center of the optical fiber preform 600 in the longitudinal direction. In the optical fiber preform 600, this center portion is a portion with stable characteristics and high non-circularity. Therefore, it is expected that the non-circularity of the lead-out portions 700a and 700b in the center portion of the optical fiber preform 600 will be high.

However, if the manufacturing apparatus 11 is used, even when the non-circularity of the trunk portion of the optical fiber preform 600 is less than 0.2%, there are cases where the non-circularity of the lead-out portions 700a and 700b reaches from 0.6% to 1.0%. However, in the manufacturing apparatus 11, a temperature distribution occurs on the surface of the optical fiber preform 600 due to the uneven distribution of the flow of inert gas introduced from the gas introducing portion 205, and it is estimated that the non-circularity in the lead-out portions 700a and 700b will become worse. In contrast to this, in the manufacturing apparatus 10, by introducing the inert gas in a manner to circulate around the optical fiber preform 600, it is possible to prevent the increase in the non-circularity and to improve the manufacturing yield of the optical fiber.

In the above examples, the introduction nozzles 800 have structures for introducing the inert gas in directions overlapping with lines tangent to the optical fiber preform 600. However, the introduction direction of the inert gas is not limited to a direction parallel to the tangent line.

For example, the inert gas flows in a ring-shaped empty space between the optical fiber preform 600 and the gas introducing portion 205, and therefore there are cases where the resistance of the inert gas introduction decreases when the introduction direction of the inert gas is directed relatively close to the center of the optical fiber preform 600. Accordingly, in the manufacturing apparatus 10, if the introduction direction of the inert gas is inclined relative to the normal line of the optical fiber preform 600, an effect occurs whereby the inert gas is introduced smoothly and uniformly. Furthermore, in addition to a structure that sets the introduction direction of the inert gas according to the direction of the introduction nozzle 800 itself, a structure may be used in which a flow straightening plate or the like is provided in the introduction flow path of the inert gas.

The flow of the introduced inert gas preferably has a component parallel to the longitudinal direction of the optical fiber preform 600, in order for the introduced inert gas to flow in the spiral shape. In the manufacturing apparatus 10, a component in the longitudinal direction of the optical fiber preform 600 occurs naturally due to the rising of the inert gas heated by the heating apparatus 200, the release of the inert gas from the bottom end of the furnace body 201 in the drawing, and the like, but such a directional component may be actively applied in the flow of the inert gas. Therefore, the inert gas may be introduced in a direction inclined relative to the longitudinal direction of the optical fiber preform 600, for example. Furthermore, in addition to the introduction nozzles 800 that introduce the inert gas horizontally, other introduction nozzles 800 may be added that have a vertical component in the introduction direction.

Furthermore, in the above example, the manufacturing apparatus 10 includes a pair of the introduction nozzles 800. However, the number of introduction nozzles 800 is not limited to this and a greater number of introduction nozzles 800 may be provided. Yet further, the positions where the introduction nozzles 800 are provided may be a plurality of different positions in the longitudinal direction of the optical fiber preform 600. In addition, in the above example, the introduction nozzles 800 are provided on the top side of the heating apparatus 200 in the drawings, but the introduction nozzles 800 may also be arranged on the bottom side of the heating apparatus 200.

Furthermore, in the above example, the optical fiber preform 600 suitable for optical fiber drawing was manufactured by performing the elongation machining on the optical fiber base material 400 and then performing the lead-out machining on the manufactured optical fiber preform 600. However, the restriction of the increase of the non-circularity in the manufacturing apparatus 10 including the gas introducing portion 205 is also effective when the only one of the elongation machining and the lead-out machining is performed. Furthermore, if the lead-out machining is performed without severing the optical fiber preform 600, i.e. if machining is performed to provide the lead-out portions 700a and 700b at the end portion of the optical fiber preform 600, it is possible to restrict the increase in the non-circularity with the structure of the manufacturing apparatus 10.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### List of Reference Numerals

10, 11: manufacturing apparatus, 100: feeding apparatus, 101: column, 102: ball screw, 103: raising and lowering section, 104: hanging shaft, 200: heating apparatus, 201: furnace body, 202: heater, 203: thermal insulation material, 204: muffle tube, 205, 208: gas introducing portion, 206: top chamber, 207: bottom furnace shutter, 300: pulling apparatus, 301: guide roller, 302: pulling roller, 400: optical fiber base material, 500: dummy bar, 600: optical fiber preform, 600a: top-side optical fiber preform, 600b: bottom-side optical fiber preform, 700a, 700b: lead-out portion, 800: introduction nozzle

What is claimed is:

1. A manufacturing method for manufacturing an optical fiber preform by heating in an inert gas atmosphere, the manufacturing method comprising:
introducing the inert gas along a surface of the optical fiber preform and causing the inert gas to circulate around the optical fiber preform with an axis of the optical fiber preform in a longitudinal direction as a center.

2. The manufacturing method according to claim 1, wherein
the inert gas is introduced in a direction parallel to a tangent line of the optical fiber preform in a plane orthogonal to the axis.

3. The manufacturing method according to claim 1, wherein
the inert gas is introduced from positions adjacent in the longitudinal direction of the optical fiber preform to a heater that heats the optical fiber preform.

4. The manufacturing method according to claim 3, wherein
the inert gas is introduced to the heater from adjacent positions at both sides of the optical fiber preform in the longitudinal direction.

5. The manufacturing method according to claim 1, wherein
the inert gas is introduced in a manner to have a motion component parallel to the axis.

6. The manufacturing method according to claim 5, wherein
the inert gas having the motion component parallel to the axis is further introduced along the surface of the optical fiber preform.

7. The manufacturing method according to claim 1, wherein
the inert gas is introduced from a plurality of positions.

8. The manufacturing method according to claim 1, wherein
the inert gas includes at least one of argon gas and nitrogen gas.

9. The manufacturing method according to claim 1, wherein
the optical fiber preform is manufactured by applying a tensile force to an optical fiber base material heated in an atmosphere into which the inert gas is introduced.

10. The manufacturing method according to claim 9, wherein
a constricted shape is formed at an end portion of the optical fiber preform.

11. A manufacturing apparatus for manufacturing an optical fiber preform by heating in an inert gas atmosphere, the manufacturing apparatus comprising:
an introduction nozzle that introduces the inert gas along a surface of the optical fiber preform and causes the inert gas to circulate around the optical fiber preform with an axis of the optical fiber preform in a longitudinal direction as a center.

12. The manufacturing apparatus according to claim 11, wherein
the introduction nozzle introduces the inert gas in a direction parallel to a tangent line of the optical fiber preform in a plane orthogonal to the axis.

13. The manufacturing apparatus according to claim 11, wherein
the introduction nozzle introduces the inert gas from positions adjacent in the longitudinal direction of the optical fiber preform to a heater that heats the optical fiber preform.

14. The manufacturing apparatus according to claim 13, wherein
the introduction nozzle introduces the inert gas to the heater from adjacent positions at both sides of the optical fiber preform in the longitudinal direction.

15. The manufacturing apparatus according to claim 11, wherein
the introduction nozzle introduces the inert gas in a manner to have a motion component parallel to the axis.

16. The manufacturing apparatus according to claim 15, further comprising:
another introduction nozzle that introduces the inert gas having the motion component parallel to the axis along the surface of the optical fiber preform.

17. The manufacturing apparatus according to claim 11, wherein
the introduction nozzle introduces the inert gas from a plurality of positions.

18. The manufacturing apparatus according to claim 11, wherein
the introduction nozzle introduces the inert gas including at least one of argon gas and nitrogen gas.

19. The manufacturing apparatus according to claim 11, comprising:
a heating section that heats an optical fiber base material in an atmosphere into which the inert gas is introduced; and
a pulling section that pulls one end of the optical fiber base material heated by the heating section, wherein
the manufacturing apparatus manufactures the optical fiber preform.

20. The manufacturing apparatus according to claim 19, wherein
a constricted shape is formed at an end portion of the optical fiber preform.
